(19) United States
(12) Patent Application Publication
(10) Pub. No.: US 2012/0192423 A1
(43) Pub. Date: Aug. 2, 2012

(54) MULTI-FUNCTION VALVE EXCHANGE APPARATUS AND METHOD OF USING SAME

(76) Inventors: Ivan Vesely, Larkspur, CO (US); Christopher Michael Sprague, Broomfield, CO (US)

(21) Appl. No.: 13/500,658

(22) PCT Filed: Oct. 14, 2010
(86) PCT No.: PCT/US10/52638

§ 371 Date: Apr. 6, 2012

Related U.S. Application Data
(60) Provisional application No. 61/251,869, filed on Oct. 15, 2009.

(51) Int. Cl. B23P 6/00; B23P 19/00

(52) U.S. Cl. 29/890.121; 29/700

(57) ABSTRACT

A multi-function valve exchange apparatus including an alignment tool for locating tools of the multi-function valve exchange apparatus proximate to an installed cardiovascular valve assembly comprised of a base member and an exchangeable valve member detachably coupled thereto; a stabilizer tool for grabbing the base member and preventing the base member from moving during a procedure for exchanging the existing valve member with a new valve member; removal and collapsing tools for uncoupling and removing the existing valve member; and an installation tool for installing a new exchangeable valve member having a new leaflet set. A method for exchanging a valve member uses the multi-function valve exchange apparatus to facilitate removal of the existing exchangeable valve member and installation of the new exchangeable valve member.

### RELATED APPLICATION

This application claims the benefit of U.S. Provisional Application No. 61/251,869, filed Oct. 15, 2009, and is fully incorporated herein by reference.

### FIELD OF THE INVENTION

The present invention relates generally to the field of cardiovascular valves, and more particularly to a multi-function valve exchange apparatus that includes multiple tools for facilitating the removal and installation of an exchangeable valve member, and a method for exchanging the valve member.

### BACKGROUND OF THE INVENTION

A cardiovascular valve assembly has been developed that comprises an exchangeable valve member, including a leaflet component, and a docking station (also referred to as a “base member”). The docking station is permanently installed in a patient, and the valve member is detachably mounted or engaged with the docking station to allow exchange of the valve member.

The present invention provides a multi-function valve exchange apparatus (also referred to as a “tool set”) for facilitating the removal and installation of an exchangeable valve member, and a method for exchanging the valve member.

### SUMMARY OF THE INVENTION

In accordance with one aspect of the present invention, there is provided a multi-function valve exchange apparatus for transapical use that incorporates multiple tools, including tools for alignment, valve stabilization, valve member extraction, and valve member installation.

According to another aspect of the present invention, there is provided a multi-function valve exchange apparatus for facilitating exchange of a valve member of a valve assembly that includes a valve member detachably coupled to a base member. The apparatus is comprised of a stabilizer tool for preventing movement of the base member during exchange of a valve member, the stabilizer tool including first engagement means moveable between an expanded position and a collapsed position, wherein said first engagement means engages with the base member in the expanded position; a removal tool for uncoupling the valve member from the base member, the removal tool including second engagement means moveable between a collapsed position and an expanded position, wherein said second engagement means engages with the valve member of said valve assembly in the expanded position to uncouple said valve member from said base member; and an installation tool for coupling a new valve member to the base member, the installation tool including a third engagement means moveable between a collapsed position and an expanded position, wherein said third engagement means engages with the new valve member, and moves the new valve member between expanded and collapsed positions.

According to still another aspect of the present invention, there is provided a method for exchanging a valve member of a valve assembly that includes the valve member detachably coupled to a base member. The method includes the steps of: locating a new valve member in front of the valve member detachably coupled to the base member using an installation tool, said new valve member being inserted through the valve assembly; uncoupling the valve member from base member using a removal tool engageable with the valve member detachably coupled to the base member; removing the uncoupled valve member through the base member using the removal tool; and coupling the new valve member to the base member using the installation tool.

An advantage of the present invention is the provision of a multi-function valve exchange apparatus that facilitates the extraction of an exchangeable valve member from an installed docking station, wherein the existing exchangeable valve member is uncoupled from the installed docking station.

Another advantage of the present invention is the provision of a multi-function valve exchange apparatus that facilitates the installation of an exchangeable valve member, wherein a new exchangeable valve member is engaged with the installed docking station.

Still another advantage of the present invention is the provision of a method for exchanging a valve member by extraction of an existing valve member from an installed docking station, and installation of a replacement valve member.

These and other advantages will become apparent from the following description taken together with the accompanying drawings and the appended claims.

### BRIEF DESCRIPTION OF THE DRAWINGS

The invention may take physical form in certain parts and arrangement of parts, an embodiment of which will be described in detail in the specification and illustrated in the accompanying drawings which form a part hereof, and wherein:

FIG. 1 is an exploded view of a cardiovascular valve assembly comprising a base member and an exchangeable valve member that is detachably coupled thereto, said assembly adapted for use in connection with the multi-function valve exchange apparatus of the present invention;

FIG. 2 is a perspective view of the valve assembly of FIG. 1, wherein the valve member is shown coupled to the base member;

FIG. 3 illustrates an alignment tool and a stabilizer tool, according to an embodiment of the present invention, located at a surgical site in the vicinity of an installed valve assembly comprised of the base member and the valve member shown in FIGS. 1 and 2;

FIG. 4 illustrates the alignment tool in engagement with the old valve member and the stabilizer tool in engagement with the base member;

FIG. 5 illustrates the stabilizer tool in engagement with the base member, after removal of the alignment tool;

FIG. 6 illustrates a removal tool, a collapsing tool (associated with the removal tool), and an installation tool, according to an embodiment of the present invention, wherein the removal, collapsing, and installation tools are inserted through a tubular member of the stabilizer tool, said installation tool holding a new valve member;

FIG. 7 illustrates the installation tool holding the new valve member in front of the old valve member, the removal tool in engagement with the old valve member, and the collapsing tool;

FIG. 8 illustrates the removal tool uncoupling the old valve member from the installed base member;

FIG. 9 illustrates the removal tool and the collapsing tool in engagement with the uncoupled old valve member;

FIG. 10 illustrates retraction of the removal and collapsing tools to withdraw the old valve member, and the installation tool holding the new valve member in alignment with the base member for coupling thereto;

FIG. 11 is an exploded view of the alignment tool according to an embodiment of the present invention;

FIG. 12 is a cross-sectional view of a portion of the alignment tool, as assembled;

FIG. 13 is a cross-sectional view of a portion of the alignment tool, as assembled, wherein the alignment tool is shown in a collapsed position;

FIG. 14 is a perspective view of the stabilizer tool according to an embodiment of the present invention;

FIG. 15 is a cross-sectional view of the stabilizer tool, taken along lines 15-15 of FIG. 14;

FIG. 16 is a perspective view of the removal tool according to an embodiment of the present invention;

FIG. 17 is an enlarged perspective view of a portion of the removal tool shown in FIG. 16;

FIG. 18 is a cross-sectional view of a portion of the removal tool shown in FIG. 16;

FIG. 19 is a perspective view of the collapsing tool according to an embodiment of the present invention;

FIG. 20 is a cross-sectional view of a portion of the collapsing tool shown in FIG. 19;

FIG. 21 is perspective view of a portion of the installation tool according to an embodiment of the present invention, wherein the installation tool is in an expanded position;

FIG. 22 is a cross-sectional view of the portion of the installation tool, taken along lines 22-22 of FIG. 21; and

FIG. 23 is a cross-sectional view of a portion of the installation tool, wherein the installation tool is in a collapsed position.

### DETAILED DESCRIPTION OF THE INVENTION

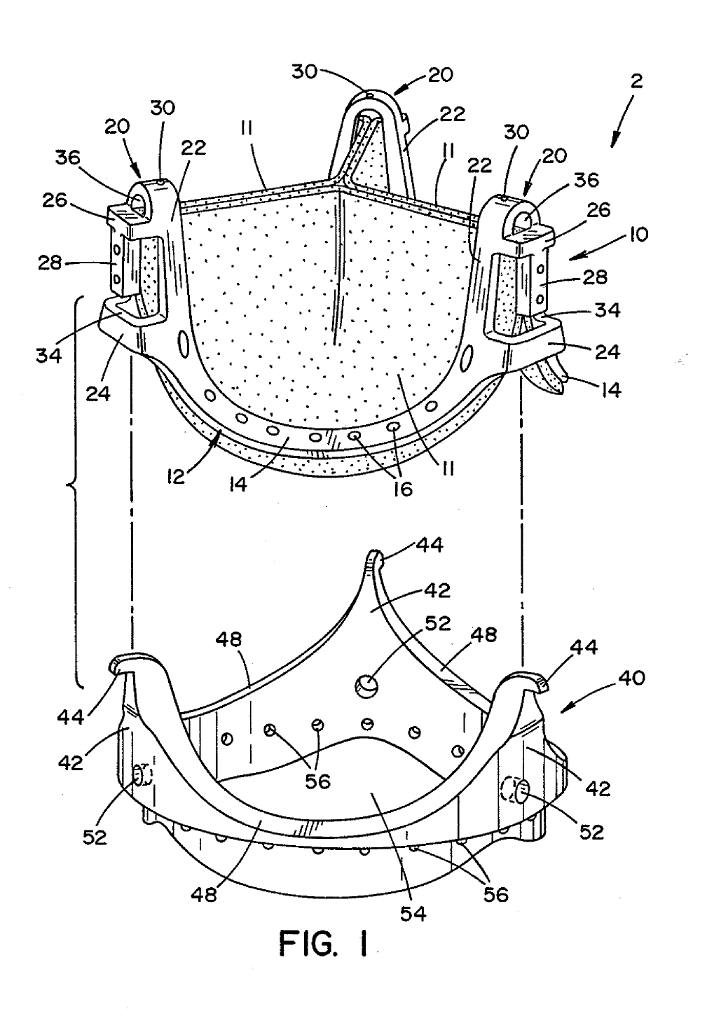

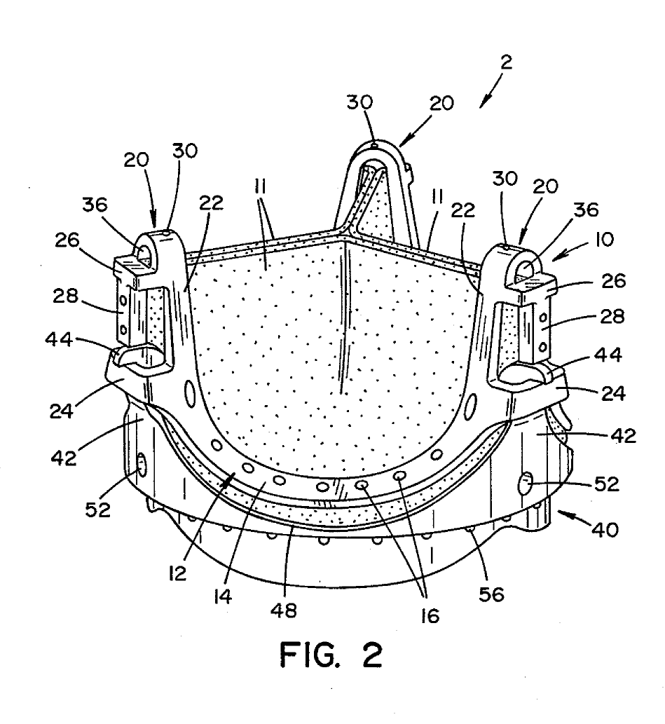

Referring now to the drawings wherein the showings are for the purposes of illustrating the present invention only and not for the purposes of limiting same, FIG. 1 shows an exploded view of a cardiovascular valve assembly 2 adapted for use in connection with the multi-function valve exchange apparatus and the valve exchange method of the present invention, described in detail below. Valve assembly 2 is comprised of a docking station or base member 40 and a valve member 10 that is detachably coupled to base member 40. FIG. 2 shows valve member 10 coupled to base member 40. In the illustrated embodiment, valve member 10 is a bioprosthetic valve. However, it is contemplated that valve member 10 may also take the form of a mechanical valve.

It should be appreciated that illustrated valve assembly 2 is intended as an example of a valve assembly adapted for use in connection with the multi-function valve exchange apparatus and the valve exchange method of the present invention, and is not intended to limit the scope thereof. Accordingly, it is contemplated that the multi-function valve exchange apparatus and the valve exchange method of the present invention are also intended for use in connection with valve assemblies having alternative designs.

Base member 40 is generally comprised of a plurality of mounting portions 42 and a plurality of arcuate sections 48 located between mounting portions 42. Mounting portions 42 function as stent posts of base member 40. Each mounting portion 42 includes an outward extending protuberance or tab 44. Mounting portions 42 and arcuate sections 48 define a generally cylindrical recess 54. A plurality of recesses 52 are formed in base member 40. Recesses 52 are provided to allow a holding or stabilizer tool (described below) to engage and hold base member 40, thereby preventing movement during a procedure for exchanging valve member 10. Recesses 52 may take the form of a hole or depression formed in base member 40.

A sewing cuff or ring (not shown) made of Dacron®, or other medical grade fabric, is sewn to the outer surface of base member 40 using holes 56 located along the circumference of base member 40. The sewing cuff or ring is used to permanently attach base member 40 to the tissue of the heart. The sewing cuff may also include a sleeve (not shown) to provide further coverage of the outer surface of base member 40.

Valve member 10 is generally comprised of a frame 12 and a plurality of valve leaflets 11 (i.e., a leaflet set) supported by frame 12. Frame 12 includes a plurality of ribbon sections 14 and coupling elements 20. Coupling elements 20 function as stent posts of valve member 10, and allow valve member 10 to be coupled and uncoupled from base member 40, as will be described below. Frame 12 is moveable between an expanded position and a collapsed position in order to facilitate removal and installation, as will be discussed below.

Each coupling element 20 is comprised of a generally U-shaped portion 22 having lower and upper crossbars 24, 26 extending across U-shaped portion 22. Upper crossbar 26 is T-shaped and includes a downward extending finger 28. Finger 28 and lower crossbar 24 define a lower slot 34. Upper crossbar 26 and the top section of U-shaped portion 22 define an upper slot 36. A fabric cover (not shown) made of a medical grade cloth may be placed over each coupling element 20. In one embodiment of valve member 10, each coupling element 20 includes an opening 30 in generally U-shaped portion 22.

Each ribbon section 14 has a generally arcuate shape, and extends between coupling elements 20. Ribbon sections 14 have an arcuate shape that matches the profile of arcuate sections 48 of base member 40, thereby forming a seal therebetween when valve member 10 is coupled to base member 40. This seal prevents blood leakage between valve member 10 and base member 40.

Frame 12 is preferably made of a flexible material having suitable elasticity to allow frame 12 to collapse into a tight bundle for convenient exchange of valve member 10 through small incisions or a trocar, and to facilitate the engagement and disengagement of coupling elements 20 and mounting portions 42, as will be described below. In the illustrated embodiment, frame 12 is made of a medical grade polymer material, such as poly-ether-ether-ketone (PEEK), polyurethane or polycarbonate. However, it is also contemplated that frame 12 may be formed of alternative materials having a suitable amount of elasticity.

As indicated above, leaflets 11 are supported by frame 12. In this regard, leaflets 11 may be sewn to ribbon sections 14 using holes 16 formed along the length of ribbon sections 14. Alternatively, leaflets 11 may be attached to ribbon sections 14 by appropriate means, such as sutures, clips, staples or other fastening devices. Leaflets 11 may be made of suitable materials, including, but not limited to, bovine pericardium, equine pericardium, ovine pericardium, porcine aortic valve tissue, small intestinal submucosa (SIS), various biodegradable substrates for tissue engineered valves, and various relatively inert polymers, such as polyurethane.

Each pair of mounting portion 42/coupling element 20 provides a protuberance-slot mechanism. However, it is also contemplated that the configuration may be reversed, wherein each coupling element 20 provides a protuberance and each mounting portion 42 provides a slot. The entire protuberance-slot mechanism is covered by a cap (not shown) that prevents fibrotic ingrowth. All exposed surfaces of valve assembly 2 are preferably covered by a fabric cover (not shown) made of Dacron®, or other medical grade fabric, as in conventional bioprosthetic valves.

Valve member 10 is coupled and uncoupled to/from base member 40 through engagement and disengagement of coupling elements 20 and mounting portion 42. Lower slot 34 of each coupling element 20 is dimensioned to receive a respective tab 44 of each mounting portion 42, thereby coupling valve member 10 to base member 40. As shown in FIG. 2, tab 44 is captured between the lower surface of finger 28 of upper crossbar 26 and the upper surface of lower crossbar 24. As discussed above, frame 12 is formed of an elastic material. Accordingly, frame 12 is dilated by outward deflection to disengage tab 44 of each mounting portion 42 from lower slot 34 of each coupling element 20. Consequently, valve member 10 is uncoupled from base member 40. Coupling and uncoupling of valve member 10 to/from base member 40 is facilitated by use of the multi-function valve exchange apparatus of the present invention, which is described in detail below. Once valve member 10 is coupled to base member 40, valve member 10 is secured such that it cannot unintentionally uncouple from base member 40. In this respect, outward deflection of frame 12 is opposite to normal cardiac forces, thus providing secure engagement.

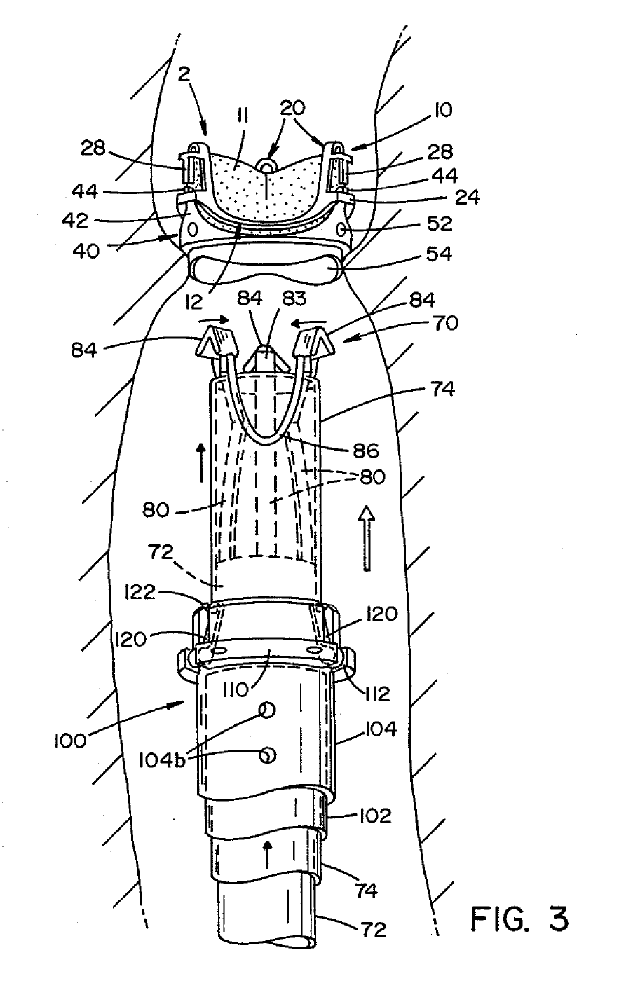

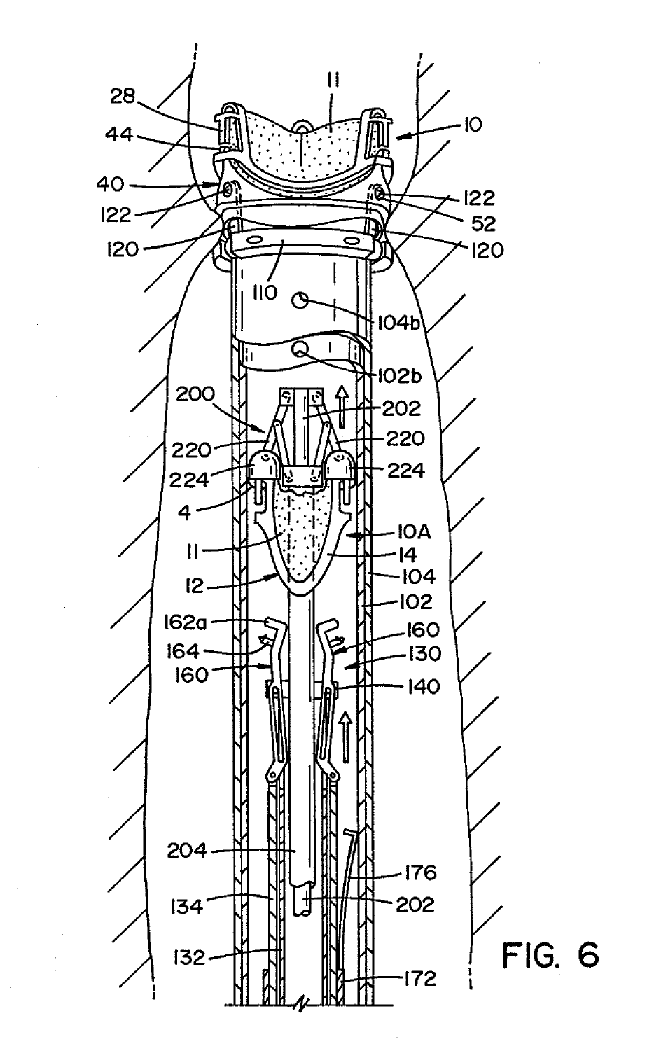

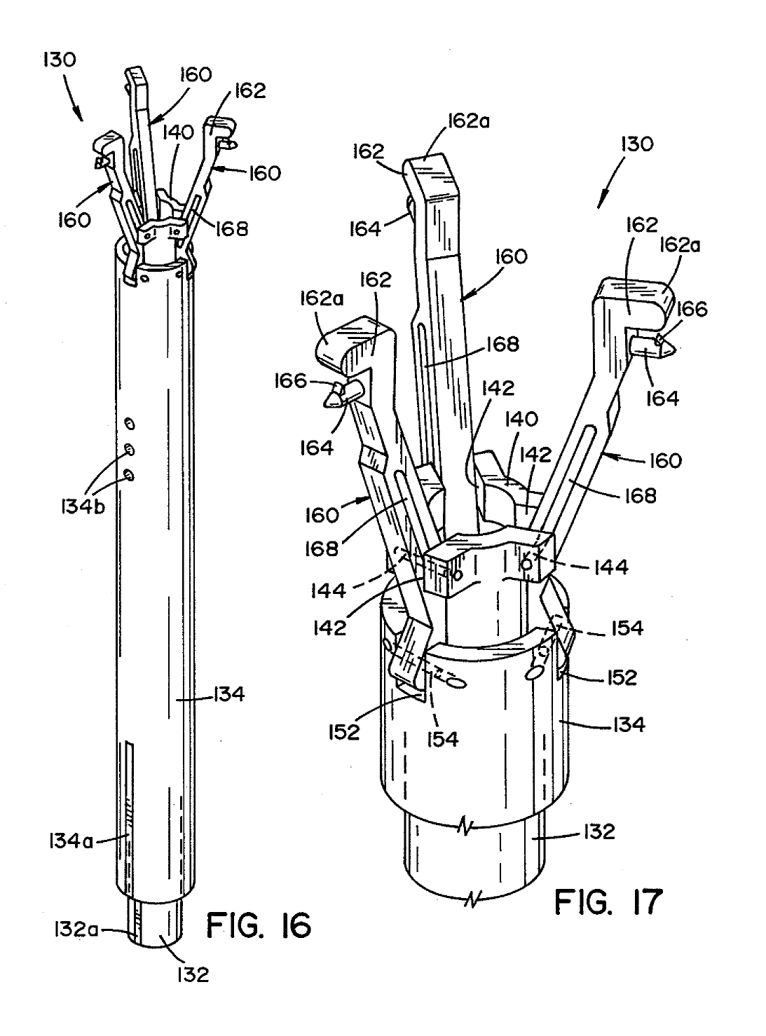

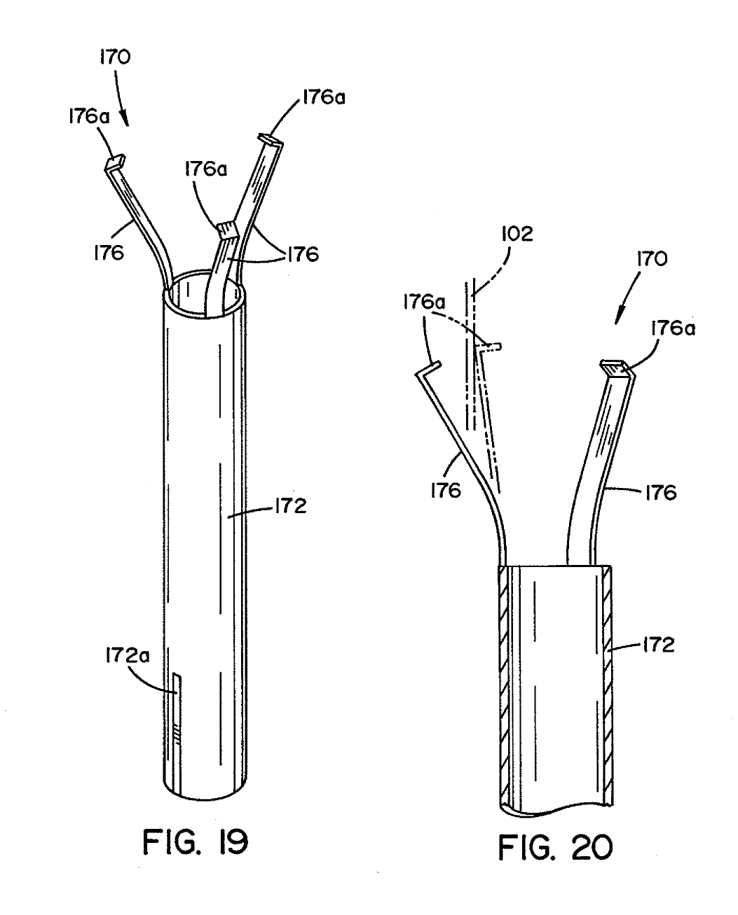

In accordance with the present invention, there is provided a multi-function valve exchange apparatus comprised of an alignment tool 70 (FIGS. 3, 4, and 11-13) for aligning tools of the multi-function valve exchange apparatus relative to valve assembly 2; a holding or stabilizer tool 100 (FIGS. 3-10 and 14-15) for holding base member 40 during a valve exchange procedure; a valve extraction or removal tool 130 (FIGS. 6-10 and 16-18) and associated collapsing tool 170 (FIGS. 19-20) for removing an existing valve member 10 from an installed base member 40; and a valve installation tool 200 (FIGS. 6-10 and 21-23) for facilitating the installation of a replacement valve member 10.

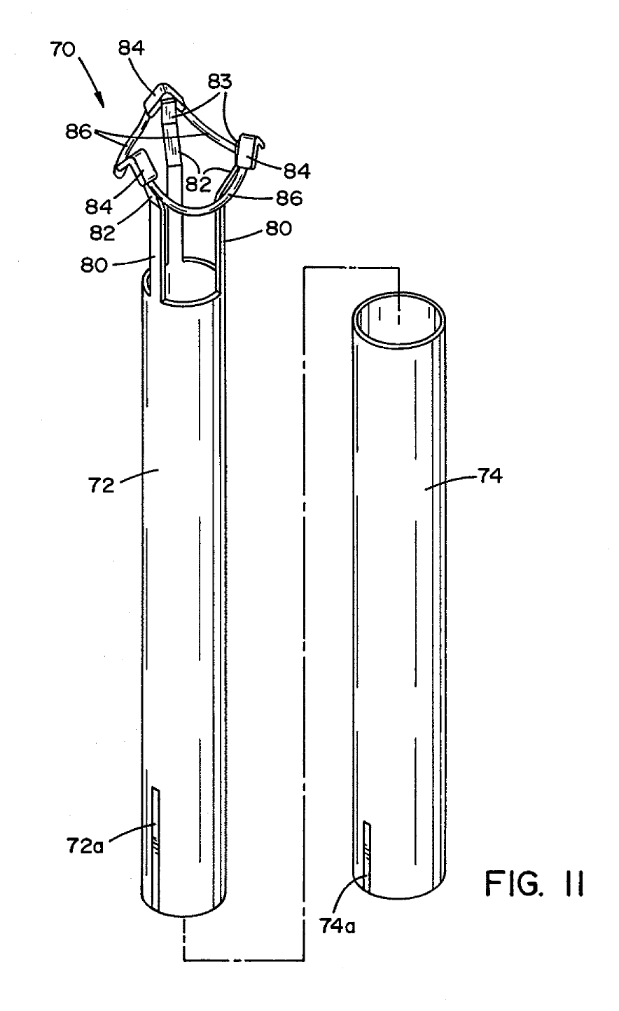

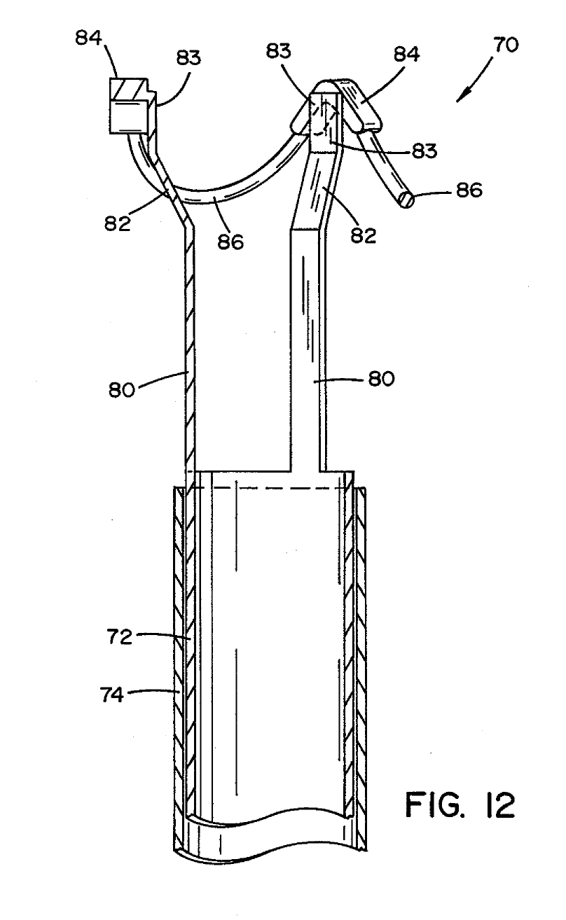

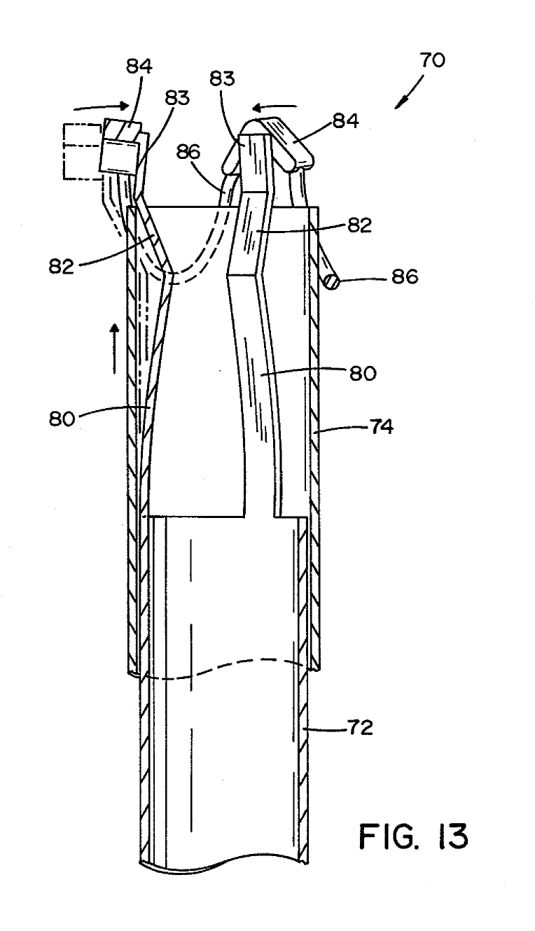

Alignment tool 70 will now be described in detail with reference to FIGS. 11-13. Alignment tool 70 is comprised of an inner tube member 72 and an outer tube member 74. Inner tube member 72 is dimensioned to fit inside of outer tube member 74 (FIGS. 12 and 13) and allow sliding movement of outer tube member 74 relative to inner tube member 72. Tube members 72 and 74 have respective locating indicators 72a and 74a that may be used to facilitate locating tube members 72, 74 relative to each other. Alignment tool 70 also includes engagement means comprising a plurality of flexible arms 80 extending outward from one end of inner tube member 72, a plurality of triangular-shaped caps 84 located respectively at distal ends 83 of arms 80, and a plurality of flexible arcuate sections 86 extending between adjacent triangular-shaped caps 84. Arms 80 include an outward bent portion 82. Arms 80 and arcuate sections 86 are preferably made of a flexible material (e.g., a medical grade polymer material) having suitable elasticity.

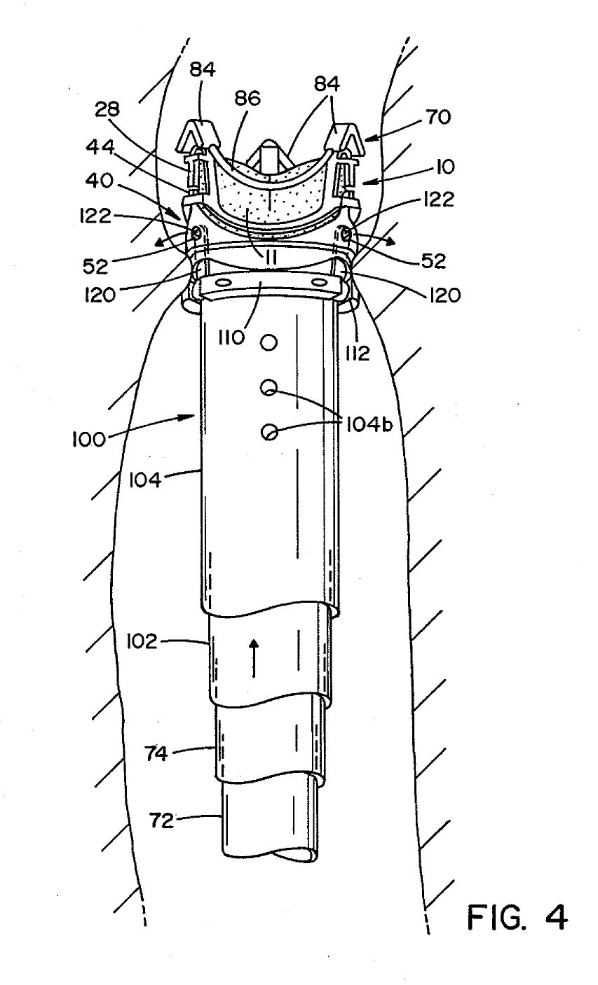

Arms 80 are moveable between an expanded position (FIGS. 11 and 12) and a collapsed position (FIG. 13). In this regard, outer tube member 74 is moved relative to inner tube member 72, such that outer tube member 74 captures outward bent portions 82 of arms 80, thereby moving arms 80 inward, as shown in FIG. 13. Inward movement of arms 80 causes arcuate sections 86 to collapse inward, thus reducing the diameter of alignment tool 70. With a smaller diameter, alignment tool 70 can be inserted through base member 40 and valve member 10, as shown in FIG. 4. Arms 80 are returned to an expanded position by moving outer tube member 74 in the reverse direction relative to inner tube member 72, such that outer tube member 74 releases outward bent portions 82. Accordingly, arms 80 move to the expanded position.

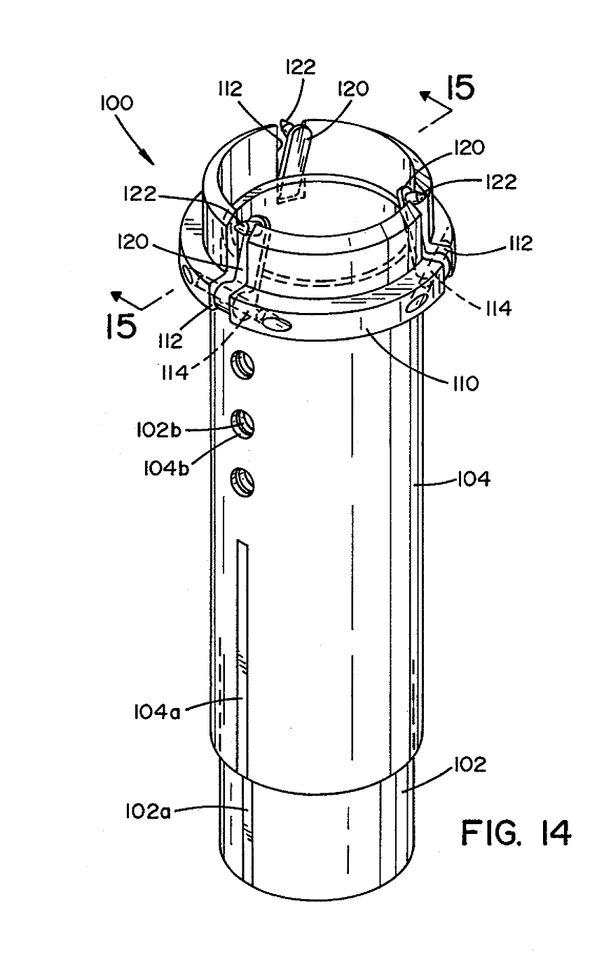

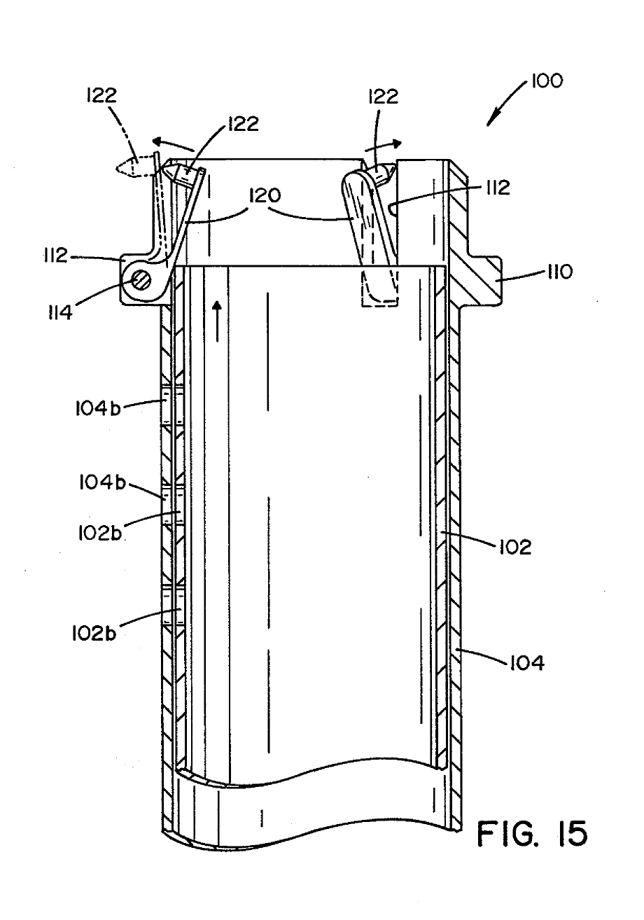

Stabilizer tool 100 will now be described in detail with reference to FIGS. 14 and 15. Stabilizer tool 100 is comprised of an inner tube member 102 and an outer tube member 104. Inner tube member 102 is dimensioned to fit inside of outer tube member 104 and allow sliding movement of outer tube member 104 relative to inner tube member 102. Tube members 102 and 104 have respective locating indicators 102a and 104a, and respective locating holes 102b and 104b that may be used to facilitate locating tube members 102, 104 relative to each other.

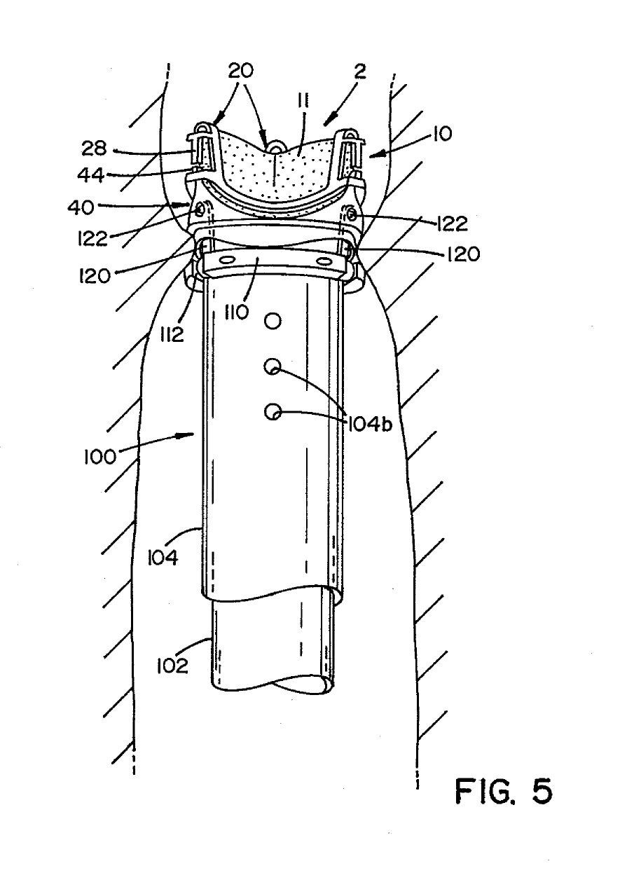

Outer tube member 104 has a collar 110 at one end thereof. Slots 112 are formed in collar 110 and extend through the end section of outer tube member 104 proximate to collar 110. Slots 112 are dimensioned to receive engagement means comprising rotatable fingers 120 that are mounted to pins 114 located in slots 112, as best seen in FIG. 15. Slots 112 allow inward rotation of fingers 120. Each finger 120 includes an outward extending protuberance 122 that is dimensioned to be received by recesses 52 formed in base member 40. Outer tube member 104 is dimensioned such that collar 110 can engage the lower surface of base member 40, as best seen in FIGS. 4 and 5.

Fingers 120 are moveable between a collapsed or disengaged position and an expanded or engaged position. Inner tube member 102 is moved relative to outer tube member 104, such that one end of inner tube member 102 pushes fingers 120 outward to engage stabilizer tool 100 with base member 40. As a result, protuberances 122 are received into recesses 52 of base member 40. Stabilizer tool 100 is disengaged from base member 40 by sliding inner tube member 102 in the reverse direction, thereby removing contact with fingers 120.

Removal tool 130 will now be described in detail with reference to FIGS. 16-18. Removal tool 130 includes an inner tube member 132 and an outer tube member 134. Inner tube member 132 is dimensioned to fit inside of outer tube member 134 and allow sliding movement of inner tube member 132 relative to outer tube member 134. Tube members 132 and 134 have respective locating indicators 132a and 134a, and respective locating holes 132b and 134b that may be used to facilitate locating tube members 132, 134 relative to each other.

Removal tool 130 also includes engagement means comprised of a plurality of rotatable legs 160 that are moveable between a collapsed position and an expanded position. Each leg 160 includes an L-shaped foot 162 having an outward extending portion 162a, a protuberance 164 (such as a pin), a barb or spike 166 extending from protuberance 164. Each leg 160 also includes an elongated slot 168. Legs 160 are connected between inner tube 132 and outer tube member 134, as will be described below. Outward extending portion 162a, protuberance 164 and spike 166 serve as a gripping member that is dimensioned to engage and decouple valve member 10 from base member 40 during a valve removal procedure, as will be explained below.

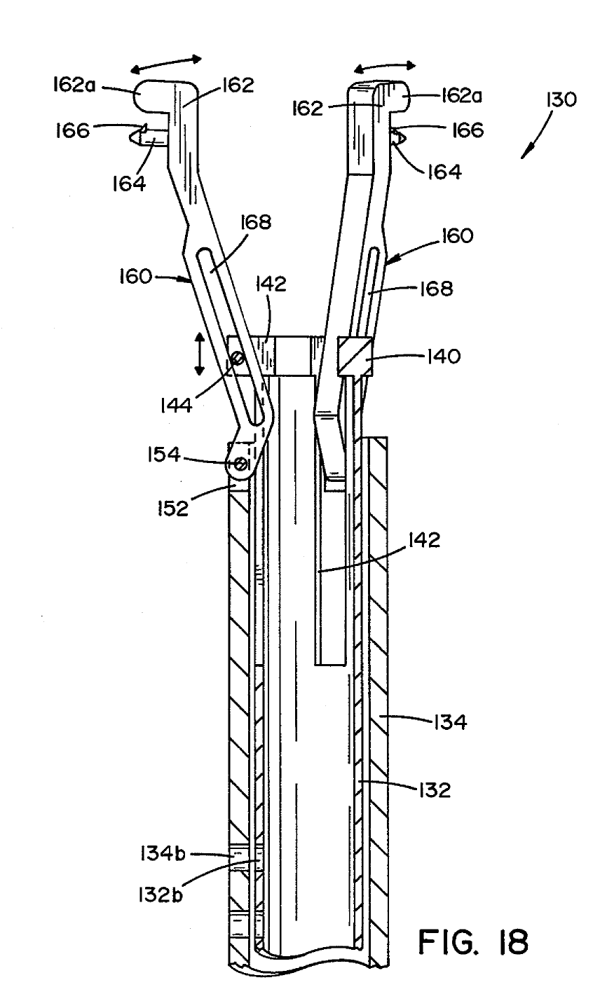

Inner tube member 132 has a slotted flange 140 at one end thereof. Slots 142 defined in flange 140 extend along a section of inner tube member 132, as best seen in FIG. 18. Slots 142 are dimensioned to receive legs 160. Pins 144, extending across slots 142, are respectively captured within elongated slots 168 of rotatable legs 160.

Outer tube member 134 has slots 152 formed at one end thereof. Slots 152 are dimensioned to receive rotatable legs 160 that are mounted to pins 154 located in slots 152.

Legs 160 are moveable between a collapsed position (FIG. 6) and an expanded position (FIGS. 16-18). In this respect, legs 160 are moved to the expanded position by sliding inner tube member 132 relative to outer tube member 134, such that slotted flange 140 of inner tube member 132 moves toward one end of outer tube member 134. Sliding inner tube member 132 in the opposite direction (i.e., away from the one end of outer tuber member 134) relative to outer tube member 134 moves legs 160 to the expanded position.

Collapsing tool 170 is a tool associated with removal tool 130, and will now be described in detail with reference to FIGS. 19-20. Collapsing tool 170 includes a tube member 172 dimensioned to fit over outer tube member 134 of removal tool 130, and allow sliding movement of tube member 172 relative to inner and outer tube members 132, 134 of removal tool 130. Tube member 172 has a locating indicator 172a to facilitate locating tube member 172 relative to tube members 132, 134.

Collapsing tool also includes an engagement means comprising a plurality of flexible fingers 176 that extend from one end of tube member 172. The distal ends of fingers 176 have inward extending portions 176a. Fingers 176 are dimensioned to facilitate the capture and collapse of valve member 40 after it has been uncoupled from base member 40, as will be explained below. Fingers 176 are preferably made of a flexible material (e.g., a medical grade polymer material) having suitable elasticity.

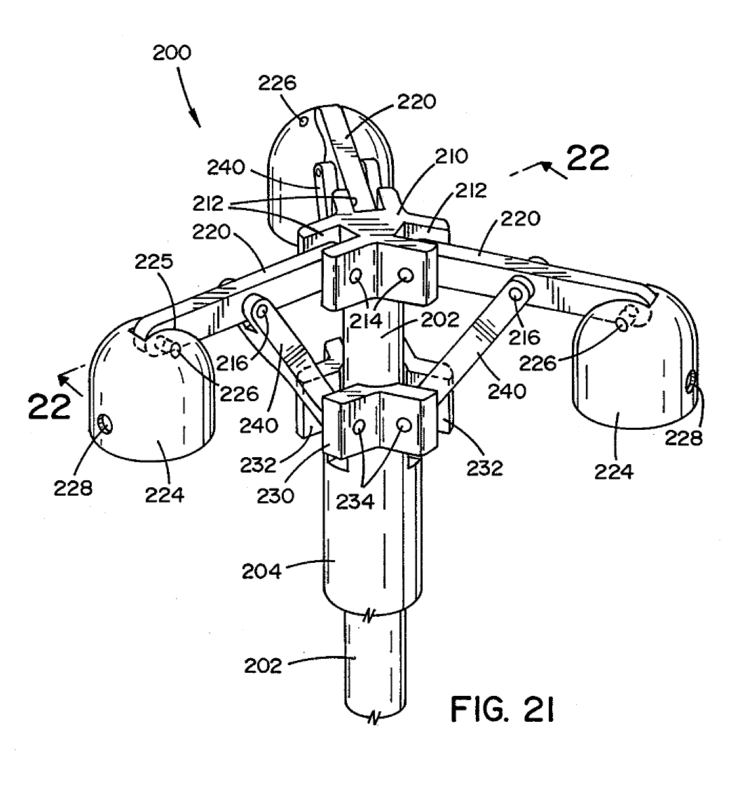

Installation tool 200 will now be described in detail with reference to FIGS. 21-23. Installation tool 200 is comprised of an inner rod 202 and an outer tube member 204. Inner rod 202 is dimensioned to fit inside of outer tube member 204 and allow sliding movement of inner rod 202 relative to outer tube member 202. Tube member 204 may include locating indicators and/or holes (not shown) to facilitate locating inner rod 202 relative to tube member 203, or to facilitate locating installation tool 200 relative to other tools of the present invention.

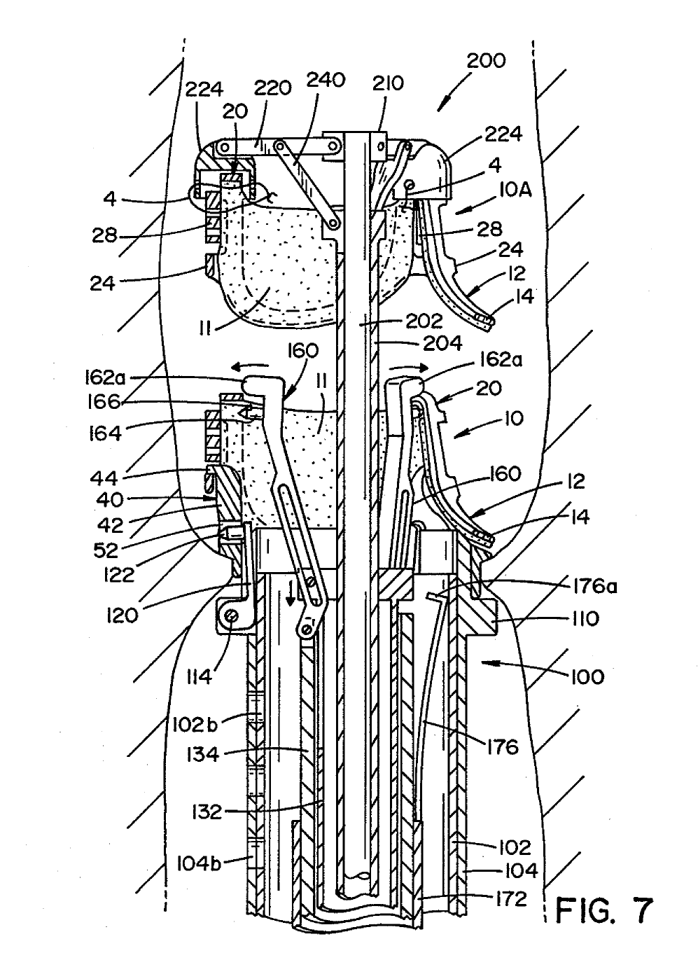

Inner rod 202 has a slotted flange 210 at one end thereof. Slots 212 of flange 210 are dimensioned to receive engagement means comprising rotatable arms 220. Rotatable arms 220 are mounted to pins 214 located in slots 212. Rotatable cups 224 are respectively mounted to the distal end of arms 220 by pins 226. Each cup 224 includes a slot 225 to allow free rotation, and a plurality of holes 228. Cups 224 are dimensioned to receive U-shaped portion 22 of valve member 10, thereby gripping valve member 10. Wires or sutures 4 (FIG. 7) may be threaded through holes 228 to temporarily secure U-shaped portions 22 to cups 224 during an installation of a new valve member 10. After the new valve member has been coupled to the base member 40, sutures 4 are removed from the new valve member 10, as will be discussed below. It should be appreciated that sutures 4 may be threaded through holes 228 wherein both ends of each suture 4 pass through inner tube member 132 of removal tool 130. This arrangement of sutures 4 allows easy complete removal of sutures 4 after installation of new valve member 10.

Outer tube member 204 has a slotted flange 230 at one end thereof. Slots 232 of flange 230 are dimensioned to receive rotatable links 240. Links 240 are rotatably mounted at a first end to outer tube member 204 by pins 234. Links 240 are also rotatably mounted at a second end to arms 220 by pins 216.

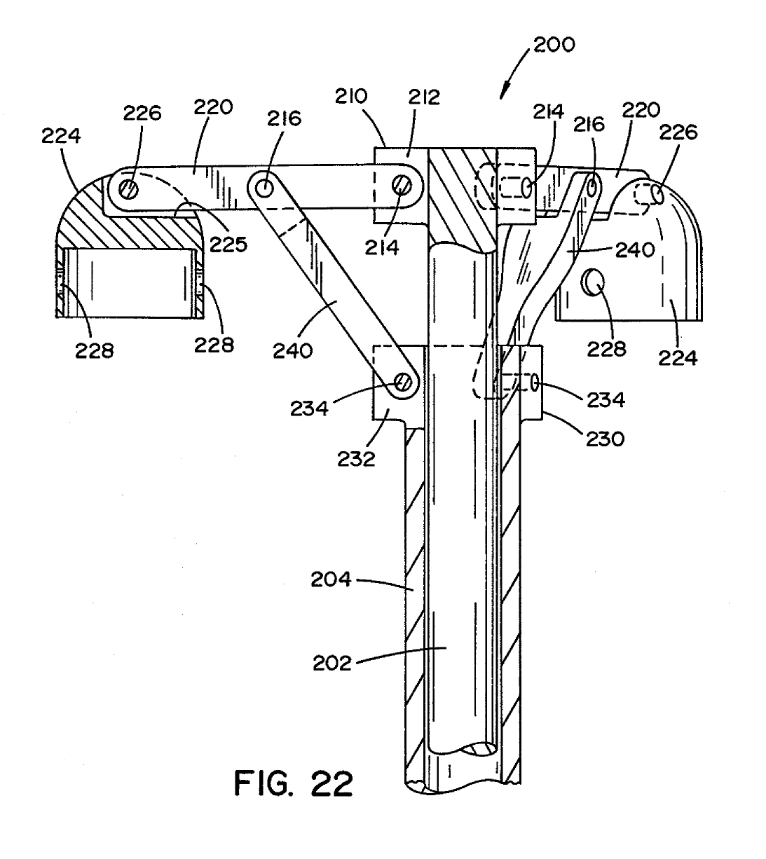

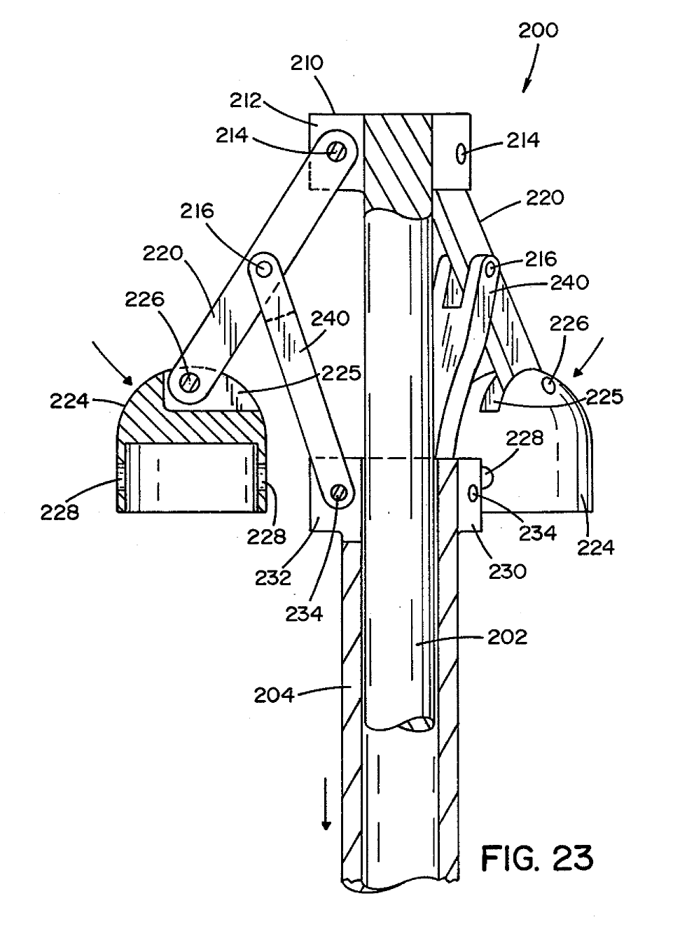

Arms 220 are moveable between a collapsed position (FIG. 23) and an expanded position (FIGS. 21 and 22). In this respect, arms 220 are moved to the expanded position by sliding inner rod 202 relative to outer tube member 204, such that flange 210 of inner rod 202 moves toward flange 230 of outer tube member 204. Sliding inner rod 202 in the opposite direction relative to outer tube member 204 moves arms 220 to the collapsed position.

A method for exchanging an old valve member 10 (having an old leaflet set) with a new valve member 10A (having a new leaflet set), and a detailed description of the operation of the multi-function valve exchange apparatus will now be described in detail with particular reference to FIGS. 3-10. Valve member 10A is substantially the same as valve member 10 shown in FIGS. 1 and 2.

In the illustrated embodiment, alignment tool 70 and stabilizer tool 100 are located together at the surgical site, as shown in FIG. 3. In this regard, inner tube member 102 of stabilizer tool 100 is dimensioned to receive inner and outer tube members 72, 74 of alignment tool 70.

Deployment of alignment tool 70 will now be described. Arms 80 of alignment tool 70 are moved from an expanded position to a collapsed position. In this regard, outer tube member 74 is moved relative to inner tube member 72, such that outer tube member 74 captures outward bent portions 82 of aims 80, thereby moving arms 80 inward, as shown in FIGS. 3 and 13. As discussed above, inward movement of arms 80 causes arcuate sections 86 to collapse inward, thus reducing the diameter of alignment tool 70.

Arms 80 of alignment tool 70 are inserted through base member 40 and valve member 10 in order to locate triangular-shaped caps 84 in front of coupling elements 20. Thereafter, arms 80 are returned to the expanded position by moving outer tube member 74 in the reverse direction relative to inner tube member 72, whereby outer tube member 74 releases outward bent portions 82. Alignment tool 80 is then located such that triangular-shaped caps 84 fit over respective coupling elements 20 (FIG. 4), thereby providing a reference orientation for the tools of the multi-function valve exchange apparatus relative to valve assembly 2. Locating indicators 72a, 74a of alignment tool 70 and locating indicators 102a, 104a of stabilizer tool 100 may be used to orient stabilizer tool 100 in a desired position relative to alignment tool 70.

Deployment of stabilizer tool 100 will now be described. After alignment tool 70 is positioned as shown in FIG. 4, stabilizer tool 100 is moved into an operative position to stabilize base member 40 during the valve exchange process. In this regard, both inner tube member 102 and outer tube member 104 are moved to locate collar 110 of outer tube member 104 in contact with the lower surface of base member 40. Next, inner tube member 102 is moved relative to outer tube member 104, such that one end of inner tube member 102 pushes rotating fingers 120 outward to engage with base member 40. As a result, protuberances 122 of fingers 120 are received by recesses 52 of base member 40 (FIG. 4). Removable pins (not shown) may be inserted through locating holes 102b and 104b in order to maintain fingers 120 in engagement with base member 40.

After stabilizer tool 100 engages base member 40 as described above, alignment tool 70 is removed by reversing the steps described above with respect to deployment of alignment tool 70. With arms 80 collapsed, outer tube member 74 of alignment tool 70 can be withdrawn, along with inner tube member 72, from inside inner tube member 102 of stabilizer tool 100. In FIG. 5, alignment tool 70 has been withdrawn.

Deployment of removal tool 130 and installation tool 200 will now be described. Inner tube member 132 of removal tool 130 is dimensioned to receive inner and outer tube members 202, 204 of installation tool 200. Inner tube member 102 of stabilizer tool 100 is dimensioned to receive removal tool 130 (with legs 160 in a collapsed position) and installation tool 200 (with arms 220 in a collapsed position), as shown in FIG. 6. Furthermore, inner tube member 132 of removal tool 130 is dimensioned to receive inner and outer tube members 202, 204 of installation tool 200.

As indicated above, wires or sutures 4 may be used to temporarily secure new valve member 10A to cups 224 during an installation of new valve member 10A. After new valve member 10A has been coupled to the base member 40, sutures 4 are removed.

Installation tool 200 is moved to extend through base member 40 and old valve member 10 such that new valve member 10A, held by cups 224, is located in front of old valve member 10. After new valve member 10A is located in front of old valve member 10, arms 220 of installation tool 200 are moved from the collapsed position to the expanded position in order to move new valve member 10A from a collapsed position to an expanded position, as shown in FIG. 7.

Removal tool 130 is moved to extend through base member 40 and old valve member 10, such that a section of U-shaped portion 22 of old valve member 10 is captured between outward extending portion 162a and protuberance 164, as legs 160 of removal tool 130 are moved from the collapsed position to the expanded position (FIG. 7). Spike 166 provides an additional gripping surface for gripping U-shaped portion 22.

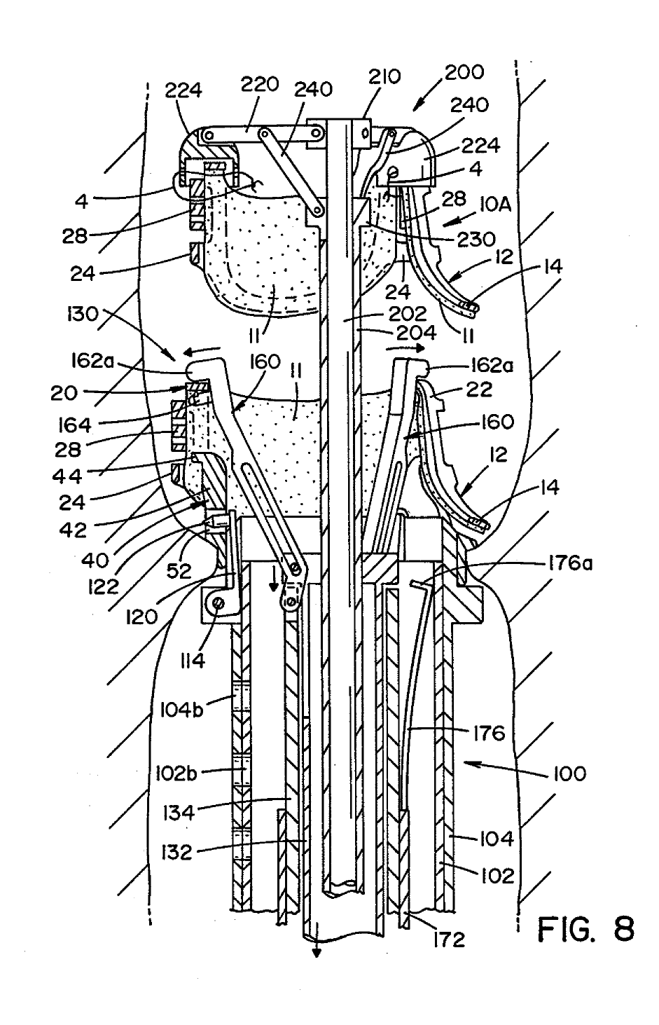

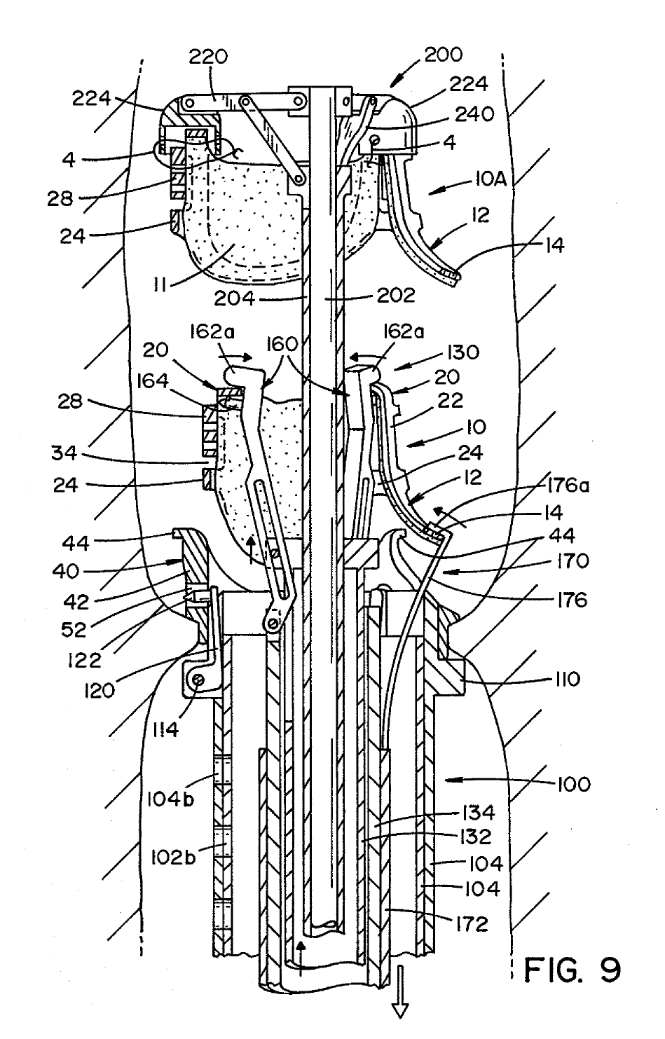

Inner tube member 132 is moved relative to outer tube member 134 in order to move legs 160 from the collapsed position to the expanded position. When legs 160 of removal tool 130 are in the fully expanded position, old valve member 10 is decoupled from base member 40 by expansion of frame 12 (FIG. 8). Removal tool 130 is then moved such that old valve member 10 located further forward of base member 40 (FIG. 9).

Next, collapsing tool 170 is deployed to facilitate the collapse of old valve member 10 held by legs 160 of removal tool 130. In this regard, tube member 172 is inserted between inner tube member 102 of stabilizer tool 100 and outer tube member 134 of removal tool 130, as shown in FIGS. 7 and 8. Inner tube member 102 is dimensioned to receive tube member 172, while tube member 172 is dimensioned to receive outer tube member 134 of removal tool 130. Collapsing tool 170 is advanced through base member 40 to locate fingers 176 in engagement with old valve member 10. In particular, inward extending portions 176a engage with an upper surface of frame 12 of valve member 10, as shown in FIG. 9.

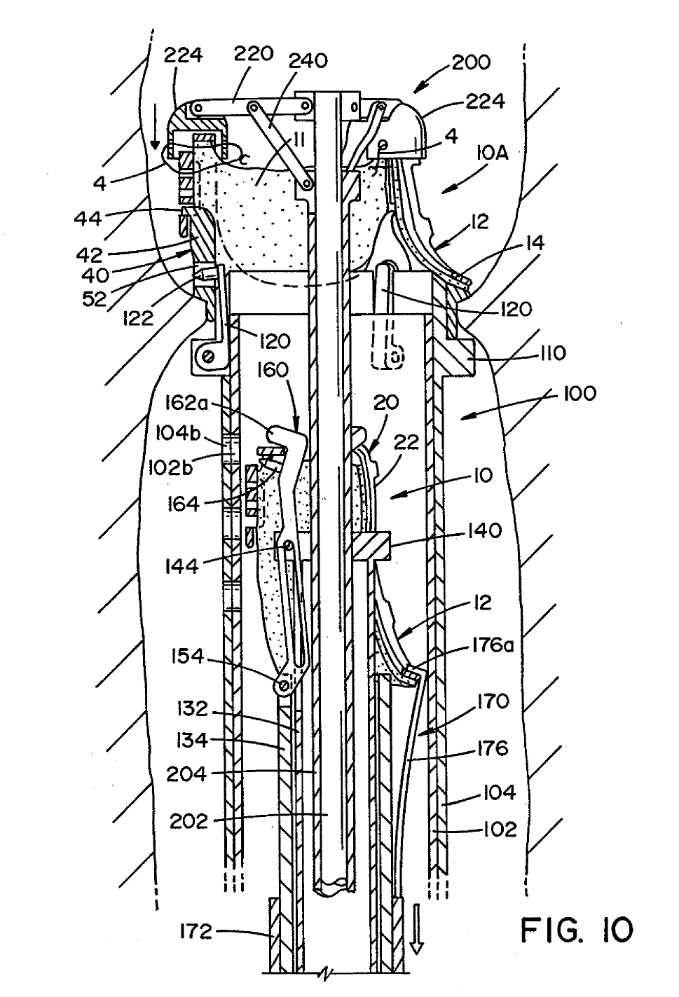

Fingers 176 act as a “shoe horn” to facilitate the collapse of old valve member 10 as removal tool 130 is withdrawn. In this respect, as removal tool 130 and collapsing tool 170 are withdrawn together through inner tube member 102 of stabilizer tool 100, fingers 176 “squeeze” frame 12. Thus, old frame member 10 will be moveable through inner tube member 102 of stabilizer tool 100 (FIG. 10). Removal tool 130 is moved from an expanded position to a collapsed position by reversing the steps for deployment of removal tool 130.

Next, installation tool 200 is moved into a position to couple new valve member 10A with base member 40. After new valve member 10A is coupled with base member 40, sutures 4 are removed from new valve member 10A. Arms 220 are then moved from the expanded position to the collapsed position, and installation tool 200 is retracted and withdrawn through inner tube member 102 of stabilizer tool 100. Thereafter, stabilizer tool 100 is retracted and withdrawn from the surgical site by reversing the above-described steps for deployment of stabilizer tool 100.

It should be understood that the tools of the multifunction valve exchange apparatus may be oriented relative to each other by use of locating indicators 72a, 74a of alignment tool 70; locating indicators 102a, 104a and locating holes 102b, 104b of stabilizer tool 100; locating indicators 132a, 134a and locating holes 132b, 134b of removal tool 130; locating indicator 172a of collapsing tool 170; and locating indicators/holes (not shown) of installation tool 200. The locating indicators may take forms other than as illustrated, including slots or other visual locating indicia. Furthermore, other locating means (not shown) may also be used to achieve the desired relative orientation of the tools. For example, it is contemplated that the tools of the present invention may have complimentary slot/groove or channel/groove arrangements or removable pins and receiving holes.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A multi-function valve exchange apparatus for facilitating exchange of a valve member of a valve assembly that includes the valve member detachably coupled to a base member, the apparatus comprising:
a stabilizer tool for preventing movement of the base member during exchange of a valve member, the stabilizer tool including first engagement means moveable between a collapsed position and an expanded position, wherein said first engagement means engages with the base member in the expanded position.

2. A multi-function valve exchange apparatus according to claim 1, wherein said first engagement means comprises a plurality of rotatable fingers having a protuberance dimensioned to be received by a recess formed in said base member.

3. A multi-function valve exchange apparatus according to claim 1, wherein said multi-function valve exchange apparatus further comprises:
a removal tool for uncoupling the valve member from the base member, the removal tool including second engagement means moveable between a collapsed position and an expanded position, wherein said second engagement means engages with the valve member of said valve assembly in the expanded position to uncouple said valve member from said base member.

4. A multi-function valve exchange apparatus according to claim 3, wherein said second engagement means includes a plurality of rotatable legs.

5. A multi-function valve exchange apparatus according to claim 3, wherein said apparatus further comprises a collapsing tool for facilitating the collapse of valve member after uncoupling from said base member.

6. A multi-function valve exchange apparatus according to claim 1, wherein said apparatus further comprises an installation tool for coupling a new valve member to the base member, the installation tool including a third engagement means moveable between a collapsed position and an expanded position, wherein said third engagement means engages with the new valve member, and moves the new valve member between expanded and collapsed positions.

7. A multi-function valve exchange apparatus according to claim 6, wherein said third engagement means include a plurality of rotationally mounted caps engageable with the new valve member.

8. A multi-function valve exchange apparatus according to claim 1, wherein said multi-function valve exchange apparatus further comprises an alignment tool for establishing a reference orientation relative to said valve assembly.

9. A multi-function valve exchange apparatus for facilitating exchange of a valve member of a valve assembly that includes a valve member detachably coupled to a base member, the apparatus comprising:
a stabilizer tool for preventing movement of the base member during exchange of a valve member, the stabilizer tool including first engagement means moveable between an expanded position and a collapsed position, wherein said first engagement means engages with the base member in the expanded position;
a removal tool for uncoupling the valve member from the base member, the removal tool including second engagement means moveable between a collapsed position and an expanded position, wherein said second engagement means engages with the valve member of said valve assembly in the expanded position to uncouple said valve member from said base member; and
an installation tool for coupling a new valve member to the base member, the installation tool including a third engagement means moveable between a collapsed position and an expanded position, wherein said third engagement means engages with the new valve member, and moves the new valve member between expanded and collapsed positions.

10. A multi-function valve exchange apparatus according to claim 9, wherein said apparatus further comprises a collapsing tool for facilitating the collapse of valve member after uncoupling from said base member.

11. A multi-function valve exchange apparatus according to claim 9, wherein said apparatus further comprises an alignment tool for establishing a reference orientation relative to said valve assembly.

12. A method for exchanging a valve member of a valve assembly that includes the valve member detachably coupled to a base member, the method comprising:
locating a new valve member in front of the valve member detachably coupled to the base member using an installation tool, said new valve member being inserted through the valve assembly;
uncoupling the valve member from base member using a removal tool engageable with the valve member detachably coupled to the base member;
removing the uncoupled valve member through the base member using the removal tool; and
coupling the new valve member to the base member using the installation tool.

13. A method according to claim 12, wherein the method further comprises:
preventing movement of the base member during exchange of a valve member using a stabilizer tool engageable with the base member;

14. A method according to claim 12, wherein said method further comprises:
collapsing the uncoupled valve member using a collapsing tool to facilitate the step of removing the uncoupled valve member; and

15. A method according to claim 12, wherein said new valve member is moved from a collapsed position to an expanded position after locating in front of the valve member detachably coupled to the base member
